(19) United States
(12) Patent Application Publication
(10) Pub. No.: US 2006/0282573 A1
(43) Pub. Date: Dec. 14, 2006

(54) Storage controller and storage system

(75) Inventors: Masami Maeda, Odawara (JP); Noboru Furuumi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/173,972

(22) Filed: Jun. 30, 2005

(30) Foreign Application Priority Data
Apr. 28, 2005 (JP) 2005-132681

(51) Int. Cl. G06F 13/38

(52) U.S. Cl. 710/62

(57) ABSTRACT

A storage controller is connected to a host system and an externally connected storage controller. This storage controller has a virtual device mapped with an actual volume of the externally connected storage controller, and a channel controller for controlling the access to the actual volume mapped to the virtual device according to a request from the host system. The channel controller divides or integrates a CCW chain transmitted from the host system for the host system to access the actual volume, and then transmits this to the externally connected storage controller.

### CROSS-REFERENCES TO RELATED APPLICATIONS

This application relates to and claims priority from Japanese Patent Application No. 2005-132681, filed on Apr. 28, 2005, the entire disclosure of which is incorporated herein by reference.

### BACKGROUND OF THE INVENTION

The present invention relates to a storage controller and a storage system.

As a disk access method of an external storage system such as a large computer system, for instance, a CKD (Count-Key-Data) method is known. With this CKD method, a CCW (channel command word) for designating the data transfer for each individual record is sequentially issued. A CCW contains a channel command, data address, chaining and data count. For example, Japanese Patent Laid-Open Publication No. H9-190292 discloses technology of using a channel command to transfer data to an external storage system. Further, Japanese Patent Laid-Open Publication No. 2001-134523 discloses a channel device for performing multiple I/O operations with one or a plurality of I/O devices, and which divides the processes of I/O operations into a plurality of tasks, and executes the subsequent process preparation processing as a low-priority task among the divided tasks.

### SUMMARY OF THE INVENTION

Incidentally, the present inventors are considering a system configuration where a storage controller connected to a host system (hereinafter sometimes referred to as a “host connected storage controller”) is further connected to an external storage controller (hereinafter sometimes referred to as an “externally connected storage controller”), and a storage device (external device) of the externally connected storage controller is provided as a storage device (internal device) of the host connected storage controller.

Nevertheless, with a configuration where the series of CCW chains transmitted from the host system to the host connected storage controller is sequentially transmitted as is, without changing the order of transmission thereof, from the host connected storage controller to the externally connected storage controller via an external connection cable, and data is read from and written into the storage device of the externally connected storage controller, in comparison to the configuration of directly reading and writing data from and in the storage device of the host connected storage controller, there is an inconvenience in that the command processing time will become lengthened. Further, the longer the external connection cable that wire-connects the host connected storage controller and externally connected storage controller, the response performance to the host system will deteriorate proportionately.

The present invention was devised in view of the foregoing problems, and an object thereof is to overcome the inconveniences described above and to improve the response performance to designations from the host system.

In order to achieve the foregoing object, the storage controller of the present invention is connected to a host system and an externally connected storage controller, and performs data processing according to a request from the host system. This storage controller has a virtual device mapped with an actual volume of the externally connected storage controller, and a channel controller for controlling the access to the actual volume mapped to the virtual device according to a request from the host system. The channel controller divides or integrates a CCW chain transmitted from the host system for the host system to access the actual volume, and then transmits this to the externally connected storage controller.

The channel controller, for instance, distributes each of the plurality of divided CCW chains to a plurality of paths upon transmitting each of the plurality of divided CCW chains to the externally connected storage controller. A path, for instance, is a physical path for connecting the storage controller and externally connected storage controller, or a plurality of logical paths set in the same physical path.

The channel controller is also able to divide the CCW chain from the host system into a number equal to the number of paths. Further, the number of CCW chains to be transmitted to each path may be changed according to the busy rate of each path, I/O response time of each path, or number of BB credits of a target port connected to each path. Moreover, as the unit for dividing the CCW chain from the host system, for example, track units or cylinder units may be used for such division.

The channel controller issues a completion report to the host system at the stage when every reply of the plurality of divided CCW chains is returned from the externally connected storage controller.

When the channel controller receives from the externally connected storage controller the reply of some CCW chains among the plurality of divided CCW chains in a case where the request from the host system is the reading of data from the actual volume, the channel controller may perform the first-out of read data to the host system while maintaining the sequence of read data without waiting for every reply of the plurality of divided CCW chains.

The storage controller of the present invention is connected to a plurality of host systems and an externally connected storage controller, and performs data processing according to a request from a plurality of host systems. This storage controller has a virtual device mapped with an actual volume of the externally connected storage controller; and a channel controller for controlling the access to the actual volume mapped to the virtual device according to the request from the host system. The channel controller substitutes a plurality of commands transmitted from each of the plurality of host systems for each of the plurality of host systems to access the actual volume with a single command, and transmits the single command to the externally connected storage controller.

When the channel controller, for instance, rearranges the plurality of commands transmitted from each of the plurality of host systems, the channel controller substitutes the plurality of commands with the single command subject to this becoming a sequential access to the actual volume.

The storage system of the present invention has a first storage controller connected to a host system and a second storage controller connected to the first storage controller. The first storage controller has a virtual device mapped with an actual volume of the second storage controller; and a channel controller for controlling the access to the actual volume mapped to the virtual device according to a request from the host system. The channel controller divides a CCW chain transmitted from the host system for the host system to access the actual volume, and transmits each of the plurality of divided CCW chains to the second storage controller. The second storage controller performs simultaneous parallel processing to each of the plurality of divided CCW chains.

According to the present invention, the response performance to designations from the host system can be improved.

### BRIEF DESCRIPTION OF THE DRAWINGS

FIG. 1 is a primary configuration of the storage system according to the present embodiment;

FIG. 2 is an explanatory diagram of a logical storage hierarchy in the storage controller;

FIG. 3 is an explanatory diagram of the processing for dividing the CCW chain according to the number of physical paths; FIG. 4 is a flowchart of the processing for dividing the CCW chain according to the number of physical paths;

FIG. 5 is a flowchart of the processing for dividing the CCW chain according to the busy rate;

FIG. 6 is a flowchart of the processing for dividing the CCW chain according to the BB credit;

FIG. 7 is an explanatory diagram of the processing for dividing the CCW chain according to the number of logical paths;

FIG. 8 is a flowchart of the processing for dividing the CCW chain according to the number of logical paths;

FIG. 9 is a flowchart of the reply processing to the divided CCW chain;

FIG. 10 is a flowchart of the reply processing to the divided CCW chain;

FIG. 11 is an explanatory diagram of the command control job table;

FIG. 12 is an explanatory diagram of the first path management table;

FIG. 13 is an explanatory diagram of the device management table;

FIG. 14 is an explanatory diagram of the externally connected DKC management table;

FIG. 15 is an explanatory diagram of the performance monitoring table;

FIG. 16 is an explanatory diagram of the second path management table;

FIG. 17 is an explanatory diagram of BB credit control;

FIG. 18 is a schematic diagram of the processing for integrating the CCW chain;

FIG. 19 is an explanatory diagram of the processing for integrating the CCW chain in command units;

FIG. 20 is a flowchart of the processing for integrating the CCW chain in command units;

FIG. 21 is a flowchart showing the command integration/division processing;

FIG. 22 is an explanatory diagram of the buffer usage quantity count table;

FIG. 23 is an explanatory diagram of the buffer usage rate monitoring table; and

FIG. 24 is an explanatory diagram of the buffer quantity monitoring table.

### DETAILED DESCRIPTION OF THE PREFERRED EMBODIMENTS

Embodiments of the present invention are now explained with reference to the attached drawings.

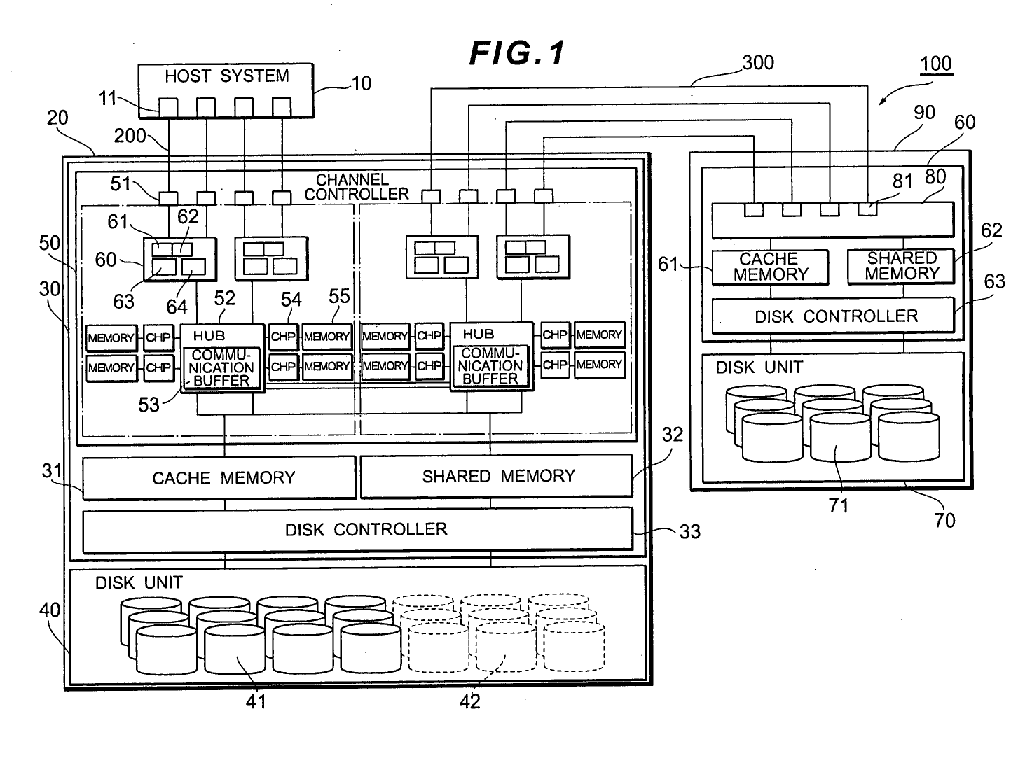

FIG. 1 shows the principal parts of a storage system 100 in the present embodiment. The storage system 100 is constituted by having a host connected storage controller 20 and an externally connected storage controller 90. The storage system 100 performs data processing according to the request from a host system 10. The host connected storage controller 20 and externally connected storage controller 90 may both be set in the same site, or may be disposed at different sites.

The host system 10, for example, is a host system having a CPU (Central Processing Unit), memory and the like, and, specifically, is a personal computer, workstation, mainframe or the like. The host system 10 is equipped with a port 11 for accessing the storage controller 20 via a host connected path 200. Further, the host system 10 is loaded with an application program such as a database that utilizes the storage resource provided by the storage controller 20.

As the host connected path 200, for instance, a LAN (Local Area Network), SAN (Storage Area Network), Internet, dedicated line, public line and so on may be arbitrarily used. Here, the data communication via the LAN is conducted according to the TCP/IP (Transmission Control Protocol/Internet Protocol) protocol. When the host system 10 is to be connected to the storage controller 20 via a LAN, the host system 10 will designate a file name and request data input/output in file units. Meanwhile, when the host system 10 is to be connected to the storage controller 20 via a SAN, the host system 10, according to a fibre channel protocol, requests the data input/output in block units, which is a data management unit of the storing area provided by a plurality of disk drives. When the host connected path 200 is a LAN, for example, a LAN-compatible network card will be used as the port 11. When the host connected path 200 is a SAN, for example, an HBA (Host Bus Adapter) will be used as the port 11.

The storage controller 20, for example, is constituted as a disk array device or the like. However, it is not limited thereto, and, for instance, the storage controller 20 may also be a virtual switch to become the SCSI target. As described later, since the storage controller 20 provides the storage resource of the externally connected storage controller 90 to the host system 10 as its own logical device, it does not always have to possess a local storage device to be controlled directly.

The storage controller 20 primarily has a disk controller (DKC) 30 and a disk unit 40. The disk controller 30, for instance, is constituted by having a channel controller 50, a cache memory 31, a shared memory 32 and a disk controller 33. The channel controller 50, cache memory 31, shared memory 32 and disk controller 33 are connected via a high-speed bus such as an ultrahigh-speed crossbar switch for transferring data based on high-speed switching operations. The channel controller 50 is constituted by having a protocol controller 60, a port 51, a hub 52, a channel control processor 54 and a memory 55.

The protocol controller 60 performs the interface control with the host system 10. The protocol controller 60 is constituted by having a transmission register 61 for storing data transmitted from the port 51 to the outside, a reception register 62 for storing data received from the outside via the port 51, a protocol control processor 63 for controlling the interface between the host system 10 and externally connected storage controller 90, and a control register 64 for storing control information required for interface control.

Each port 51 is assigned a network address (e.g., an IP address or WWN (World Wide Name)) for identifying the respective ports 51. The hub 52 connects the protocol controller 60 and channel control processor 54. The hub 52 is equipped with a communication buffer 53. The channel control processor 54 is a control processor for performing command processing, data transfer processing and so on. The channel control processor 54, for instance, has a function of dividing or integrating the CCW chain transmitted from the host system 10, and transferring this to the externally connected storage controller 90. Details regarding the division processing or integration processing of the CCW chain will be described later. The memory 55 functions as a work area of the channel control processor 54.

Incidentally, the storage controller 20 may be equipped with a plurality of channel controllers 50, and each channel controller 50 may also function as a NAS (Network Attached Storage). Further, when there is a plurality of host systems 10, each channel controller 50 is able to individually receive requests from the respective host systems 10.

The cache memory 31 is used for temporarily storing the data received from the host system 10, or the data read out from the storage devices 41, 42. The shared memory 32 stores various types of control information and the like required for system management. The command control job table, path management table, device management table, externally connected DKC management table, performance monitoring table and so on described later are stored in the shared memory 32. Incidentally, one or a plurality of storage devices 41, 42 may be used as a cache disk.

The disk controller 33 transfers data between the storage devices 41, 42 of the disk unit 40. The disk controller 33 is configured as a microcomputer system having a CPU, memory and the like. The disk controller 33 writes the data received by the channel controller 50 from the host system 10 in a prescribed address of the storage devices 41, 42 based on the write command from the host system 10, as well as reads the data from a prescribed address of the storage devices 41, 42 based on the read command from the host system 10, and transmits this to the host system 10. The disk controller 33 converts a logical address into a physical address when inputting and outputting data between the storage devices 41, 42. When the storage devices 41, 42 are managed according to RAID (Redundant Arrays of Independent Inexpensive Disks), the disk controller 33 performs data access according to the RAID configuration.

The disk unit 40 has a plurality of storage devices 41. As the storage device 41, for instance, a physical device such as a hard disk, flexible disk, magnetic tape, semiconductor memory, optical disk or the like may be used. The storage device 42 represented with dotted lines inside the disk unit 40 shows a state where the storage device (actual volume) 71 of the storage controller 90 is incorporated in the storage controller 20. In other words, with the present embodiment, the external storage device 71 existing outside when viewed from the storage controller 20 is recognized as the internal storage device of the storage controller 20, and provides the storage resource of the external storage device 71 to the host system 10. The external storage device 71 is a physical device, and the internal storage device 42 is a virtual device.

The externally connected storage controller 90 is constituted by having a channel controller 80, a cache memory 61, a shared memory 62, a disk controller 63 and a disk unit 70. The channel controller 80 has a port 81. The disk controller 63 has a plurality of processors for reading and writing data from and into the storage device 71. The configuration of the externally connected storage controller 90 is the same as the configuration of the host connected storage controller 20 described above. The port 51 of the host connected storage controller 20 and the port 81 of the externally connected storage controller 90 are mutually connected via an externally connected path 300. The command (CCW chain) transmitted from the host system 10 for the host system 10 to read from and write into the storage device 42, after being subject to division processing or integration processing in the host connected storage controller 20, is transmitted to the externally connected storage controller 90 via the externally connected path 300. The externally connected storage controller 90 reads from and writes into the storage device 71 by performing simultaneous parallel processing to the plurality of CCW chains transmitted from the host connected storage controller 20.

Incidentally, there may be one or a plurality of externally connected storage controllers 90. Further, a plurality of externally connected storage controllers 90 may be connected to the host connected storage controller 20 in a state of cascade connection. Moreover, there may be one or a plurality of host systems 10.

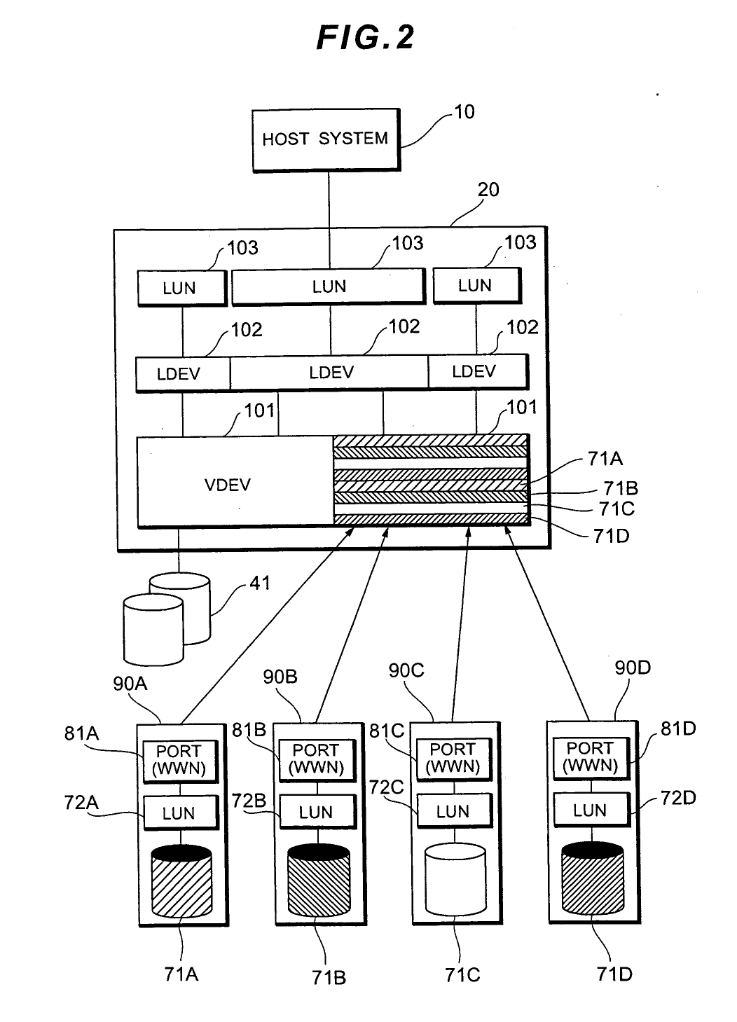

FIG. 2 shows the logical storage hierarchy in the storage controller 20. The storage controller 20 has a three-tier storage hierarchy formed from a VDEV (Virtual Device) 101, a LDEV (Logical Device) 102, and a LUN (Logical Unit Number) 103 in order from the lower tier.

The VDEV 101 is a virtual device positioned at the bottom of the logical storage hierarchy. The VDEV 101 is a virtualization of the physical storage resource, and, for example, may adapt the RAID configuration. In other words, a plurality of VDEVs 101 may be formed from a single storage device 31 (slicing), and a single VDEV 101 may be formed from a plurality of storage devices 31 (striping). The VDEV 101 depicted on the left side of FIG. 2, for instance, is virtualizing the storage device 41 according to the RAID configuration.

Meanwhile, the VDEV 101 depicted on the right side of FIG. 2 is constituted by mapping the storage device 71 of the storage controller 90. In other words, in the present embodiment, the VDEV 101 can be used as the internal volume of the storage controller 20 by mapping the logical device (LDEV) provided by the storage device 71 to the VDEV 101. In the example illustrated in FIG. 2, the VDEV 101 is configured by striping four storage devices 71A to 71D. Each of the storage devices 71A to 71D can be individually accessed by specifying the respective LUNs 72A to 72D from the respective ports 81A to 81D. Each port 81A to 81D is assigned a WWN, which is unique identifying information, and, further, since each LUN 72A to 72D is provided with a LUN number, the combination of the WWN and LUN number will enable the specification of the storage devices 71A to 71D.

The LDEV 102 is provided on the VDEV 101. The LDEV 102 is a logical device (logical volume) virtualizing the VDEV 101. A single VDEV 101 may be connected to a plurality of LDEVs 102, or a plurality of VDEVs 101 may be connected to a single LDEV 102. The LDEV 102 may be accessed via the respective LUNs 103. As described above, in the present embodiment, by connecting the storage device 71 to the intermediate storage hierarchy (VDEV 101, LDEV 102) positioned between the LUN 103 and storage device 71, the external storage device 71 can be used as an internal device of the storage controller 20.

Next, the outline of division processing of the CCW chain is explained. The storage controller 20 (hereinafter sometimes referred to as a “host connected DKC”) divides the CCW chain transmitted from the host system 10 into a plurality of MSGs (messages), distributes the plurality of MSGs to a plurality of paths (physical path or logical path), and transmits these to the storage controller 90 (hereinafter sometimes referred to as an “externally connected DKC”). In an externally connected DKC, a plurality of processors performs simultaneous parallel processing (multiple processing) to each of the plurality of MSGs as a separate CCW chain in order to improve the response performance to the host system 10. A Prefix command or Define Extent (DX)/Locate Record (LOC) command is added to the top of the CCW chain in each MSG. The host connected DKC reconfigures the write top address, write scope, number of CCW chains, channel image number and so on to be designated in the prefix command according to the number of MSGs, number of chains of each MSG, number of paths and the like.

As a method of dividing the CCW chain, for instance, the CCW chain may be divided based on the number of paths (number of physical paths or number of logical paths). The number of MSG chains to be transmitted to each path may be equal, or the number of MSG chains may be changed for each path. As a method of changing the number of MSG chains for each path, for example, the number of MSG chains may be changed according to the busy rate of each path, I/O response time of each path, communication traffic volume of each path, number of BB credits of the target port to be connected to each path, and so on. Further, the number of MSG chains may also be changed according to the distance of the physical path. Nevertheless, in order to access the same logical address using the same physical path, the channel image numbers must be set such that they do not overlap.

Moreover, as a method of dividing the CCW chain, for instance, the CCW chain may be divided in track units or cylinder units. When the setting is such that the data access is to be locked in track units or cylinder units, this can improve the response performance in an externally connected DKC by dividing the CCW chain in track units or cylinder units.

Further, as a method of dividing the CCW chain, for example, the CCW chain does not have to be divided for sequential access such as for the backup of data since the improvement of response performance to the host system 10 is only required to a lesser degree. Meanwhile, it is preferable to divide the CCW chain for random access from the host system 10 in daily business since the improvement of response performance to the host system 10 is required.

Moreover, as a method of dividing the CCW chain, for instance, priority information of the command may be referred to for dividing the CCW chain with a high priority, and refraining from dividing the CCW chain with a low priority.

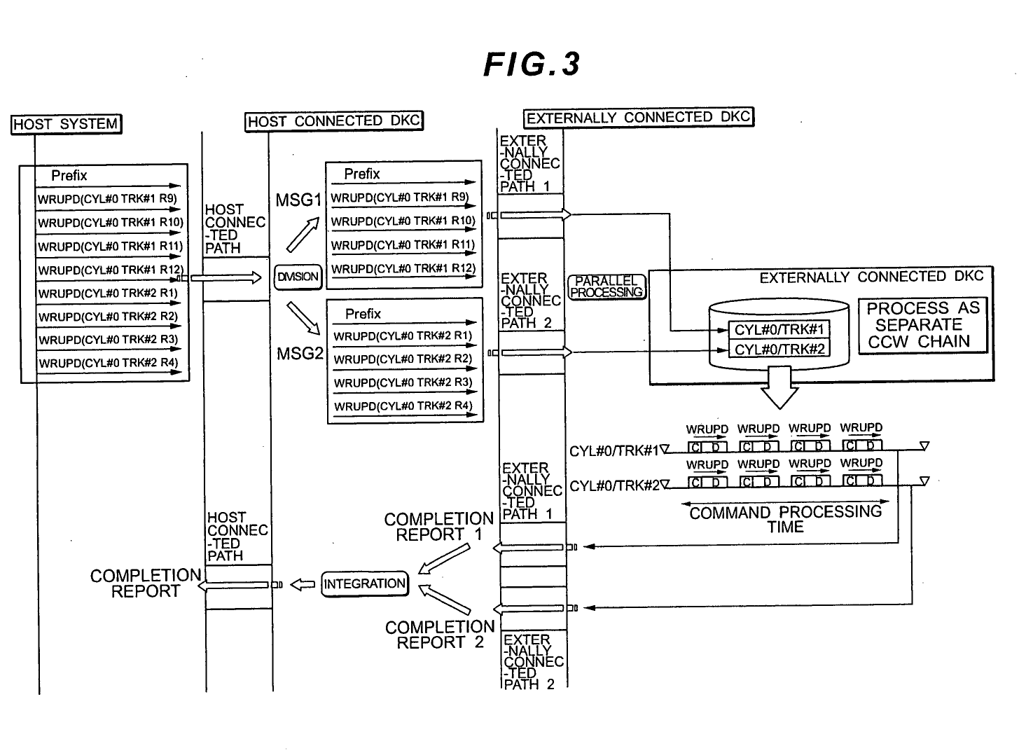

Next, the outline of processing for determining the number of divisions of the CCW chain according to the number of externally connected paths 300 (number of physical paths) and dividing the CCW chain is now explained with reference to FIG. 3.

Here, exemplified is a case where a WRUPD (write up data command) is transmitted as a CCW chain from the host system 10 to a host connected DKC. Subsequent to a prefix command designating the write top address, write scope, number of CCW chains and so on, a plurality of WRUPDs is transmitted from the host system 10 to the host connected DKC as a CCW chain. AWRUPD (CYL#L, TRK#M, RN) indicates that that this is a write command of record N of track number M of cylinder number L. AWRUPD has a counter unit C for designating the write address, data size and the like, and a data unit D for storing write data.

When the host connected DKC receives a CCW chain from the host system 10, it determines the number of divisions of the CCW chain based on the number of externally connected paths 300 connected to the storage controller 90 of the data write destination. For instance, when there are two externally connected paths 1, 2, the host connected DKC divides the CCW chain into two MSGs 1, 2, and transmits each MSG 1, 2 to the externally connected paths 1, 2. MSG 1 contains WRUPD (CYL#0, TRK#1, R9) to WRUPD (CYL#0, TRK#1, R12). The host connected DKC reconfigures the write scope and number of CCW chains designated by the prefix command of MSG 1. In this example, records 9 to 12 of track number 1 of cylinder number 0 are designated as the write scope. Four is designated as the number of CCW chains. Since the write top address of MSG 1 is the same as the write top address of the CCW chain prior to division, reconfiguration is not necessary. Further, MSG 2 contains WRUPD (CYL#0, TRK#2, R1) to WRUPD (CYL#0, TRK#2, R4). The host connected DKC reconfigures the write scope and number of CCW chains designated by the prefix command of MSG 2. In this example, record 1 of track number 2 of cylinder number 0 is designated as the write top address. Records 1 to 4 of track number 2 of cylinder number 0 are designated as the write scope. Four is designated as the number of CCW chains.

The externally connected DKC performs parallel processing to the respective MSGs 1, 2 transmitted from different externally connected paths 1, 2 as a separate CCW chain. In other words, when a certain processor is processing MSG 1, since another processor will process MSG 2 in the externally connected DKC, the parallel processing of MSGs 1, 2 is enabled. If the number of divisions of the CCW chain is made to be N, the processing time of the CCW chain in the externally connected DKC will be roughly 1/N in comparison to conventional methods. In the externally connected DKC, since each MSG 1, 2 is processed as a separate CCW chain, respective completion reports (STS) 1, 2 indicating the completion of separate write processes are transmitted from the externally connected DKC to the host connected DKC. When the host connected DKC receives the completion reports 1, 2 of each MSG 1, 2, it transmits a single completion report (STS) to the host system 10 indicating the completion of write processing.

Next, details regarding the processing of dividing the CCW chain according to the number of physical paths are explained with reference to FIG. 4.

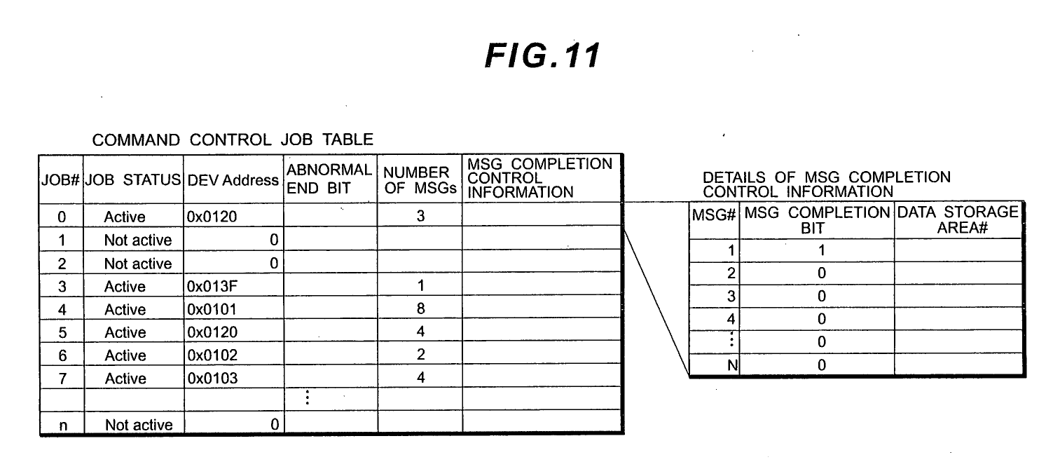

The command (CCW chain) transmitted from the host system 10 to the host connected DKC is stored in the reception register 62 via the port 51, further forwarded to the communication buffer 53, and then subject to the CCW division processing by the channel control processor 54. When the channel control processor 54 receives a command from the host system 10, it activates a command control job (S101). With this command control job activation processing, a new job number is assigned in a command control job table (FIG. 11) in relation to the command processing.

As depicted in FIG. 11, the command control job table is a table for managing, as jobs, the respective command processes to be executed when the host connected DKC receives a command from the host system 10. In this table, JOB# indicates a job number. The indication of “Active” in the column of JOB status shows that the job is active, and the indication of “Not Active” shows that the job has been completed. DEV Address indicates the logical address of the storage device 42 recognized by the host system 10. The indication of “1” in the column of Abnormal End Bit shows that the job ended abnormally, and the indication of “0” shows that the job ended normally. Number of MSGs indicates the number of divisions of the CCW chain. MSG Completion Control Information is information for managing whether the processing of each MSG is complete or incomplete. MSG# indicates the message number. The indication of “1” in the column of MSG Completion Bit shows that the processing a MSG is complete, and the indication of “0” shows that the processing of a MSG is incomplete. Data Storage Area# indicates the storage address on the cache memory 31 of the read data that was read upon replying to the read command from the host system 10.

The channel control processor 54 assigns a new job number to the JOB#, in which the JOB Status is “Not Active”, and further registers the logical address of the access destination in the DEV Address (S101).

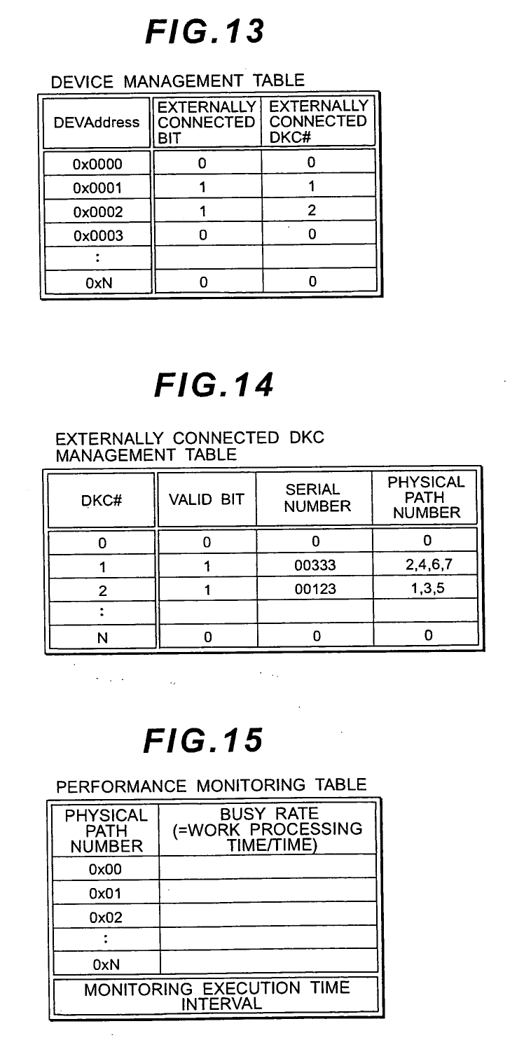

Next, the channel control processor 54 refers to the device management table (FIG. 13) and determines whether the device of the access destination is an external device (S102). As shown in FIG. 13, for each logical address (DEV Address), the device management table is a table for managing whether the device having this logical address is an external device based on the externally connected bit, and for managing the number of the externally connected DKC when the device having such logical address is an external device. The indication of “1” in the column of Externally Connected Bit shows that this is an external device, and the indication of “0” shows that this is an internal device. Externally Connected DKC# indicates the number of the externally connected DKC.

When the device of the access destination is an internal device (S102; YES), the host connected DKC performs data processing to the internal device (S110). Meanwhile, when the device of the access destination is an external device (S102; NO), the channel control processor 54 refers to the communication buffer 53 and checks the number of CCW chains (S103). In the case of a CCW chain that starts with a DX/LOC command, the number of CCW chains can be checked with the domain count of a LOC command parameter. Further, in the case of a CCW chain that starts with a prefix command, the number of CCW chains can be checked with the domain count of a prefix command parameter.

Next, the channel control processor 54 refers to the externally connected DKC management table (FIG. 14) and checks the number of physical paths (S104). As illustrated in FIG. 14, the externally connected DKC management table is a table for managing the number of the physical path to be connected to the externally connected DKC. DKC# indicates the number of the externally connected DKC. The indication of “1” in the column of Valid Bit shows that an externally connected DKC is connected, and the indication of “0” shows that an externally connected DKC is not connected. Serial Number indicates the serial number of the externally connected DKC. Physical Path Number indicates the number of the externally connected path 300 to be connected to the externally connected DKC. For instance, this example shows that four physical paths (physical path numbers 2, 4, 6, 7) are connected to the externally connected DKC of DKC#1.

Next, the channel control processor 54 divides the CCW chain into a number equal to the number of physical paths and creates each MSG (S105). The number of MSG chains will be a value obtained by dividing the number of CCW chains (domain count) with the number of physical paths. Next, the channel control processor 54 registers the number of MSGs in the command control job management table (S106).

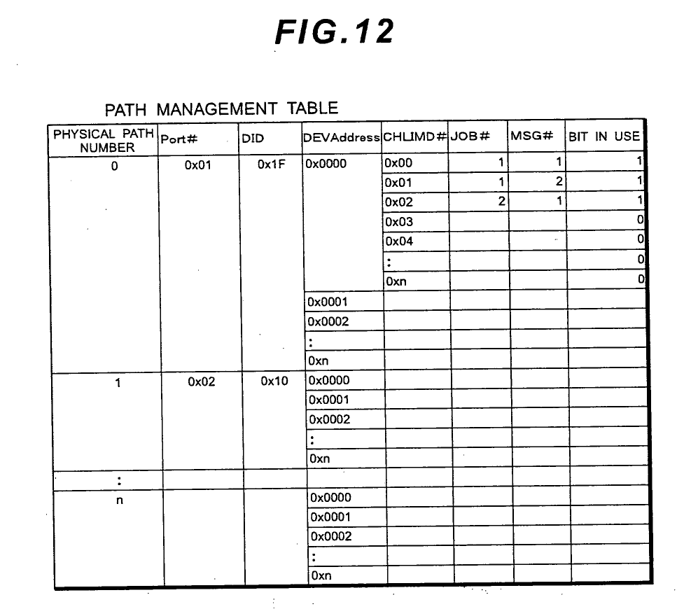

Next, the channel control processor 54 searches for an unused CHLIMG# from the first path management table (FIG. 12), and registers the JOB#, MSG# and Bit in Use in this table (S107). As shown in FIG. 12, the first path management table is a table for managing the status of use of the physical paths connected to the externally connected DKC (more specifically, the status of use of the channel image number). Physical Path Number indicates the number of the physical path. Port# indicates the number of the initiator port of the host connected DKC. DID indicates the ID of the target port of the externally connected DKC. DEV Address indicates the logical address of the access destination. CHLIMG# indicates the channel image number. JOB# indicates the job number. MSG# indicates the MSG number. Bit in Use indicates that the processing of MSG is being executed. The CHLIMG# must be changed in order to access the same logical address using the same physical path.

Next, the channel control processor 54 provides to each protocol control processor 63 a designation to forward each MSG to the externally connected DKC via each physical path (S108). Then, each protocol control processor 63 stores each MSG in the transmission register of the initiator port 51, and transmits each MSG to the target port 81 of the externally connected DKC via the externally connected path 300 (S109).

As described above, as a result of dividing the CCW chain according to the number of physical paths and making a plurality of processors perform simultaneous parallel processing to each MSG in the externally connected DKC, the response performance to designations from the host system 10 can be improved.

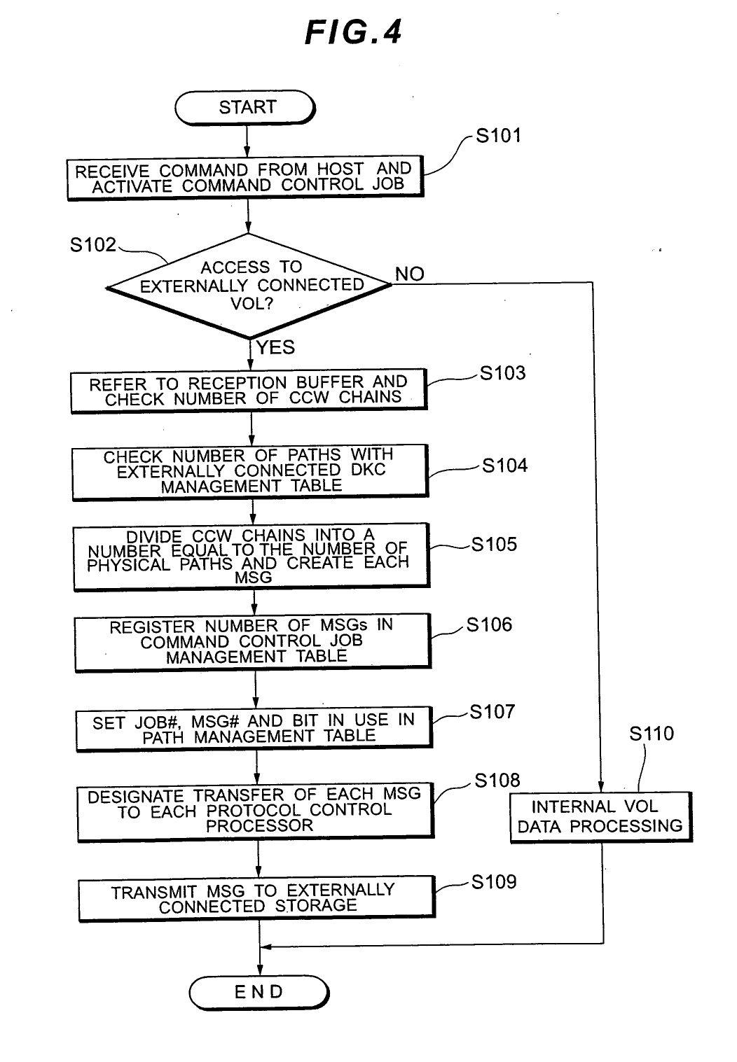

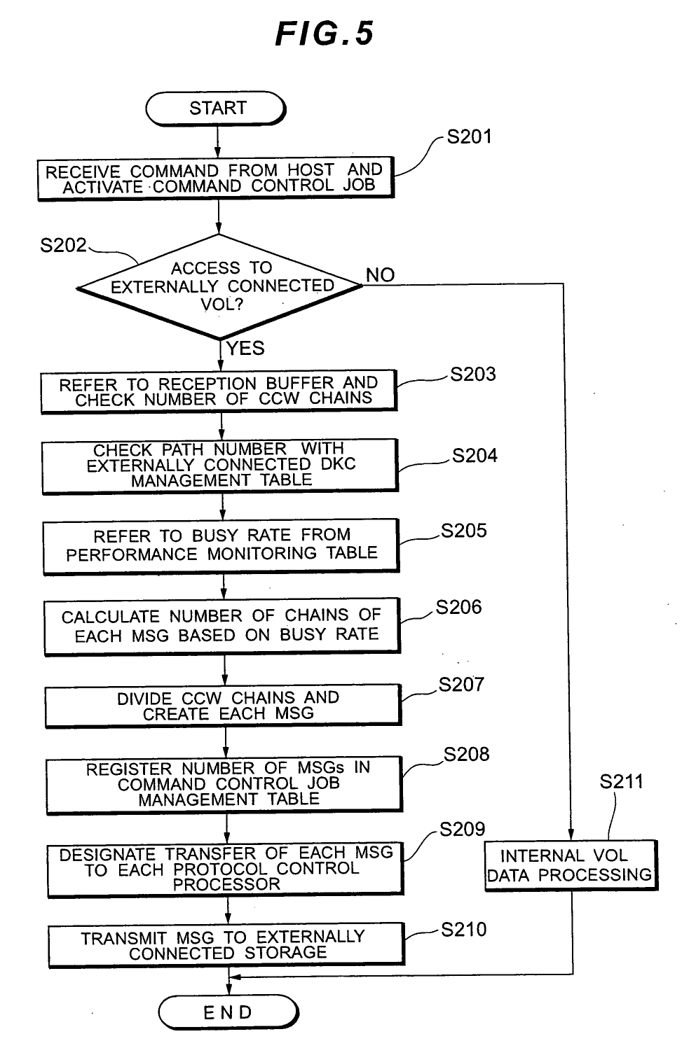

Next, details regarding the processing for dividing the CCW chain according to the busy rate of the physical path are explained with reference to FIG. 5. Since the processing steps of S201 to S203 and S207 to S211 are respectively the same as the processing steps of S101 to S103 and S105 to S110 described above, the detailed explanation thereof is omitted.

The channel control processor 54 refers to the externally connected DKC management table and checks the physical path number (S204). Next, the channel control processor 54 refers to the performance monitoring table (FIG. 15) and checks the busy rate of each physical path (S205), and calculates the number of chains of each MSG (S206). A busy rate is the operation time of the physical path per unit time. With respect to the number of chains of each MSG, for instance, by reducing the number of chains when the busy rate is high and increasing the number of chains when the busy rate is low, the busy rate of each physical path can be equalized so as to disperse the load. For example, in a case where there are three physical paths where the busy rate is 5:3:2 and twenty CCW chains are to be divided into three MSGs, the number of chains of each MSG will be 5, 7, 8 based on a setting that is inversely related to the busy rate.

As described above, by changing the number of MSG chains according to the busy rate of the physical path, the load of the physical path can be dispersed, and the response performance to designations from the host system 10 can be improved. Incidentally, in substitute for the busy rate, the number of chains of each MSG can be changed based on the I/O response time of each path, the communication traffic volume or the like.

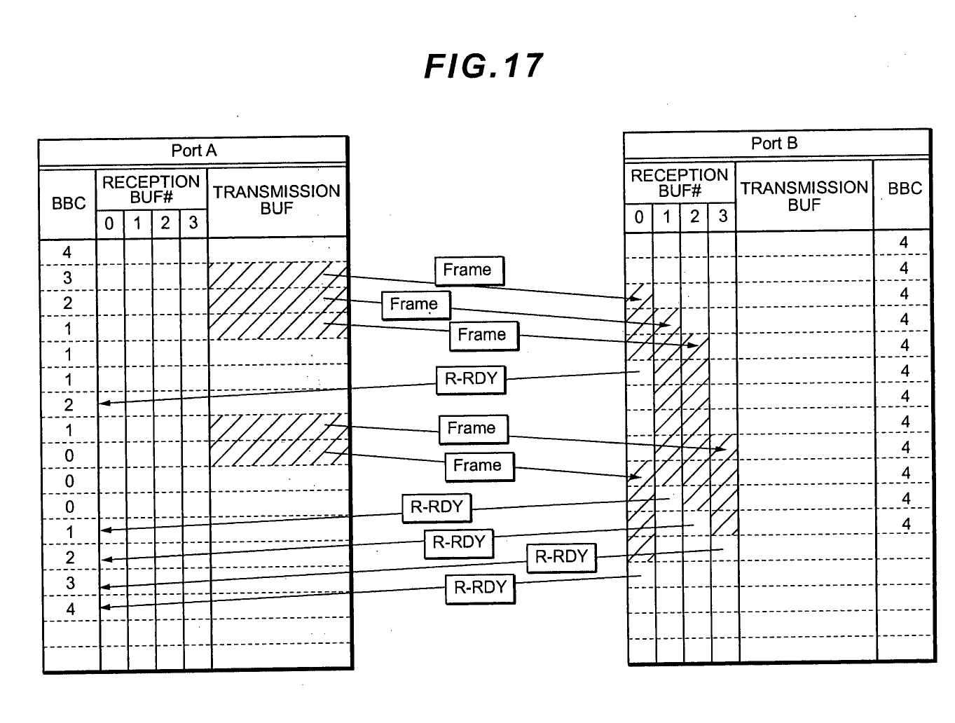

Next, the outline of Buffer-to-Buffer credit control (BB credit control) is explained with reference to FIG. 17.

The frame size on a link of a fibre channel protocol is 2 KB at maximum. Generally, a plurality of frames is transmitted and received in the transmission/reception of data/control information on a link. Here, if the target port of the externally connected DKC has sufficient buffers for storing N frames, the initiator port of the host connected DKC is able to transmit data/control information of N frames to such target port. Nevertheless, in order to transmit more frames, there must be empty buffers in the relevant target port. With Buffer-to-Buffer credit control, the number of BB credits of the opponent port and the buffer release notification are conducted between adjacent ports.

In FIG. 17, ports A and B are adjacent ports and, for instance, are connected with a fibre channel protocol. Both ports A, B have four 2 KB reception buffers. The number of BB credits (=4) of each other is notified upon link initialization processing. Specifically, the number of buffer credits is notified with the FLOGIN Frame at the establishment of the link, or the PLOGIN Frame. Further, when an empty buffer becomes available, each port issues a buffer release notification (R-RDY).

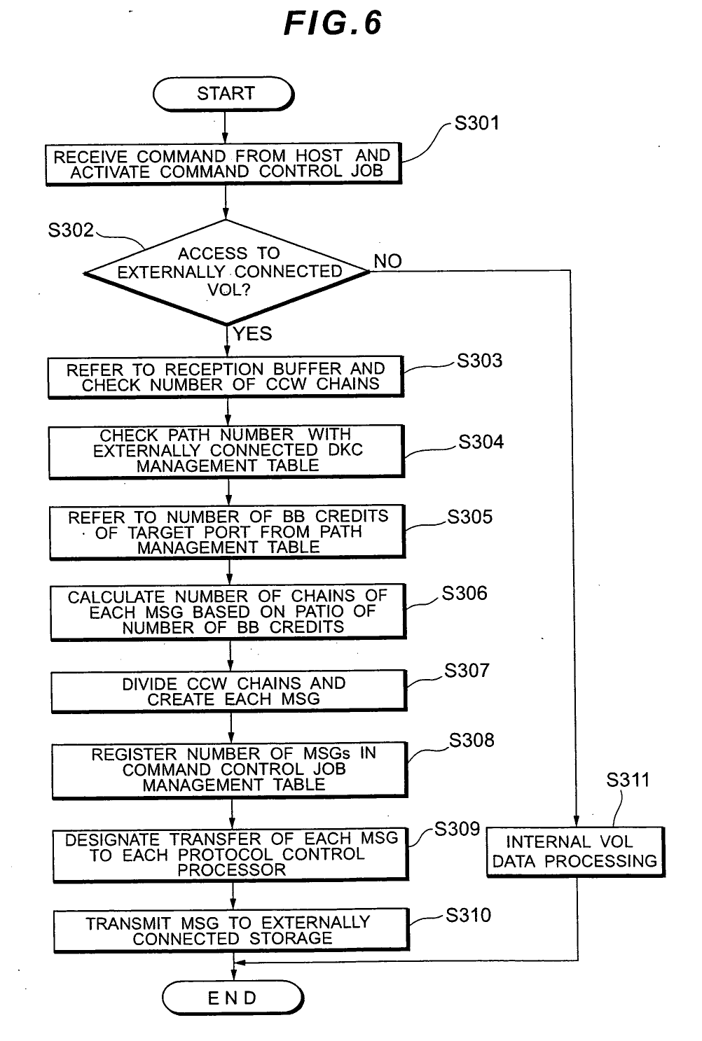

The processing for dividing the CCW chain according to the number of BB credits is now explained with reference to FIG. 6. Since the processing steps of S301 to S304 and S307 to S311 are respectively the same as the processing steps of S201 to S204 and S207 to S211 described above, the detailed explanation thereof is omitted.

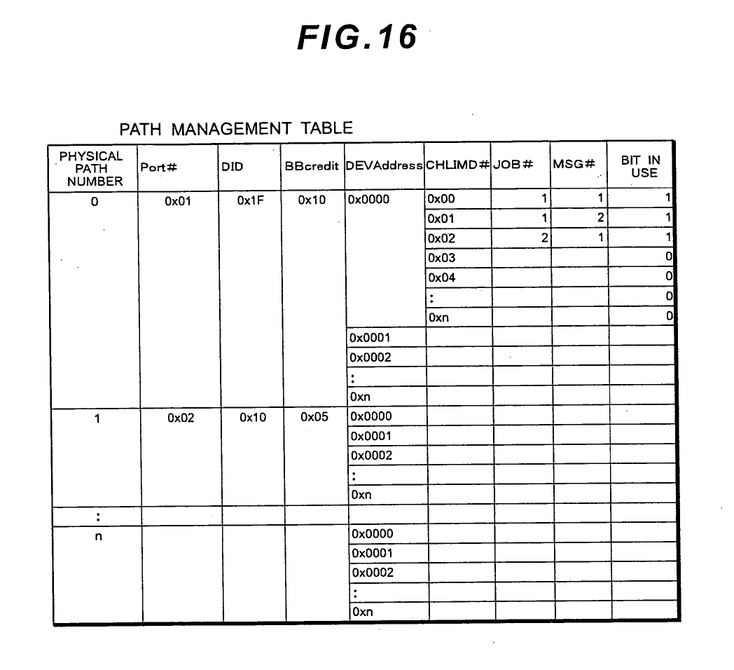

The channel control processor 54 refers to the second path management table (FIG. 16) and refers to the number of BB credits of the target port of the externally connected DKC (S305). As depicted in FIG. 16, in addition to the first path management table (FIG. 12) described above, the second path management table stores the number of BB credits of the target port for each physical path upon link initialization. The channel control processor 54 calculates the number of chains of each MSG based on the ratio of the number of BB credits (S306). For example, in a case where there are three physical paths in which the ratio of the number of BB credits is 5:3:2, if there are twenty CCW chains, the number of MSG chains to be transmitted to each physical path will be 10, 6, 4, respectively.

As described above, by changing the number of MSG chains according to the number of BB credits, appropriate flow control can be realized while improving the response performance to designations from the host system 10.

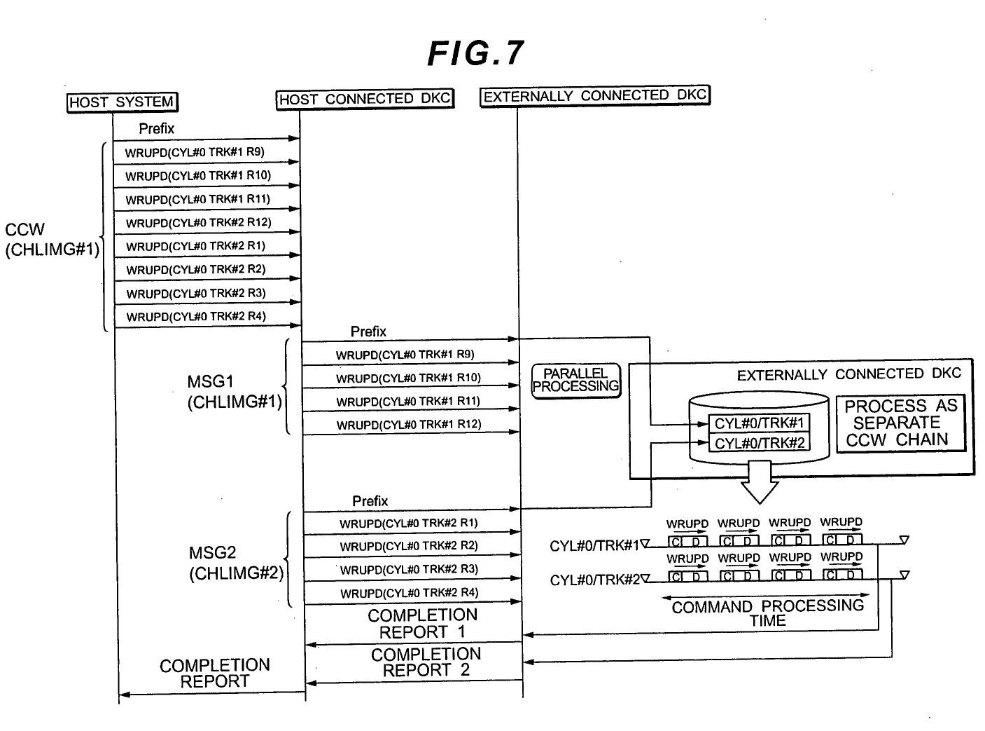

Next, the outline of processing for setting a plurality of logical paths in the same externally connected path (physical path) 300 and dividing the CCW chain is explained with reference to FIG. 7.

When a plurality of CCW chains flows on the same physical path, if the channel image number of each CCW chain is different, the externally connected DKC will recognize that each CCW chain has been transmitted from a different host system (for instance, if the host system 10 has a function for performing logical partition, the externally connected DKC will recognize that each CCW chain has been transmitted from a logically different host system). In other words, by setting the channel image numbers of the CCW chains flowing on the same physical path so that they do not overlap, a plurality of logical paths can be set in the same physical path. For example, as shown in FIG. 7, a case of the CCW chain of CHLIMG#1 being transmitted from the host system 10 to the host connected DKC will be considered. The host connected DKC, for example, divides this CCW chain into two MSGs 1, 2. The channel image number of one MSG 1 is CHLIMG#1, and the channel image number of the other MSG 2 is CHLIMG#2. The write top address, write scope, number of CCW chains, CHLIMG# and the like to be designated by the prefix command of each MSG 1, 2 will be reconfigured.

The externally connected DKC recognizes each MSG 1, 2 as a CCW chain from different host systems, and performs the parallel processing of these commands. In other words, with the externally connected DKC, when a certain processor is processing MSG 1, another processing will process MSG 2, and, therefore, the parallel processing of MSGs 1, 2 is enabled. If N number of logical paths is sent on the same physical path and the number of MSG chains flowing on each logical path is set to be approximately the same, the processing time of the CCW chain in the externally connected DKC will be roughly 1/N in comparison to conventional methods. With the externally connected DKC, since each MSG 1, 2 is processed as a separate CCW chain, respective completion reports (STS) 1, 2 indicating the completion of separate write processes are transmitted from the externally connected DKC to the host connected DKC. When the host connected DKC receives the completion reports 1, 2 of each MSG 1, 2, it transmits a single completion report (STS) to the host system 10 indicating the completion of write processing.

Incidentally, a plurality of logical paths may be set respectively in relation to a plurality of physical paths, and the CCW chain may be subject to division processing as described above.

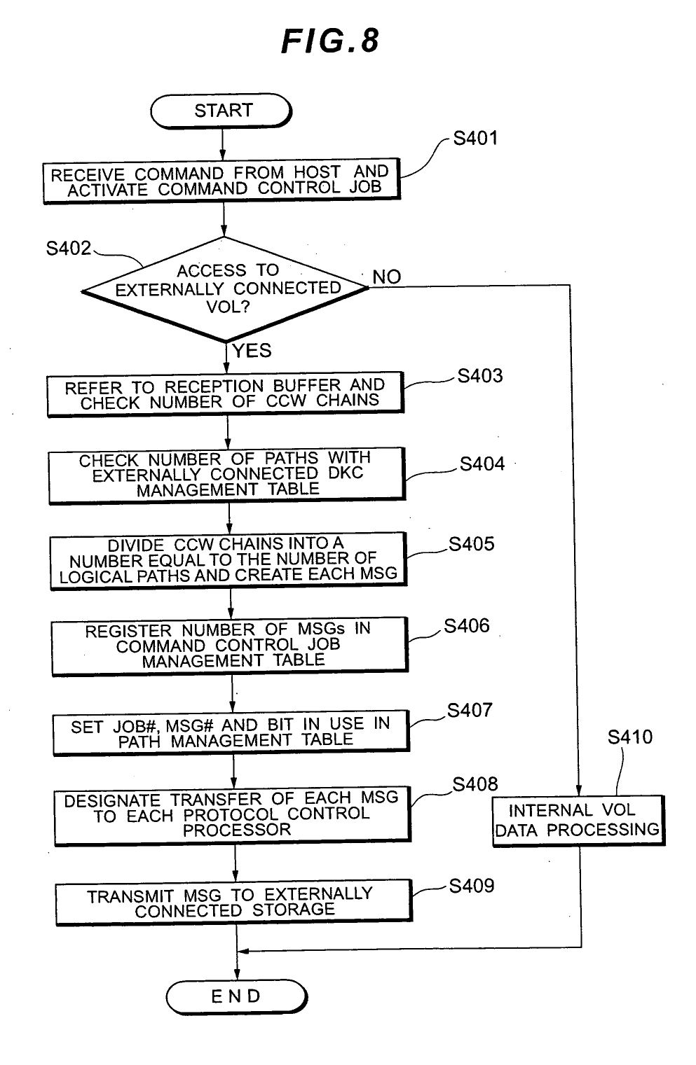

Next, details regarding the processing for dividing the CCW chain according to the number of logical paths are explained with reference to FIG. 8. Since the processing steps of S401 to S404 and S406 to S410 are respectively the same as the processing steps of S101 to S104 and S106 to S110 described above, the detailed explanation thereof is omitted.

The channel control processor 54 divides the CCW chain in a number equal to the number of logical paths and creates each MSG (S405). The number of chains of each MSG will be a value obtained by dividing the number of CCW chains (domain count) with the number of logical paths. Incidentally, when searching for an unused CHLIMG# from the first path management table (FIG. 12) and registering the JOB#, MSG# and Bit in Use in this table, the setting must be such that the CHLIMG# do not overlap when accessing the same logical address using the same physical path.

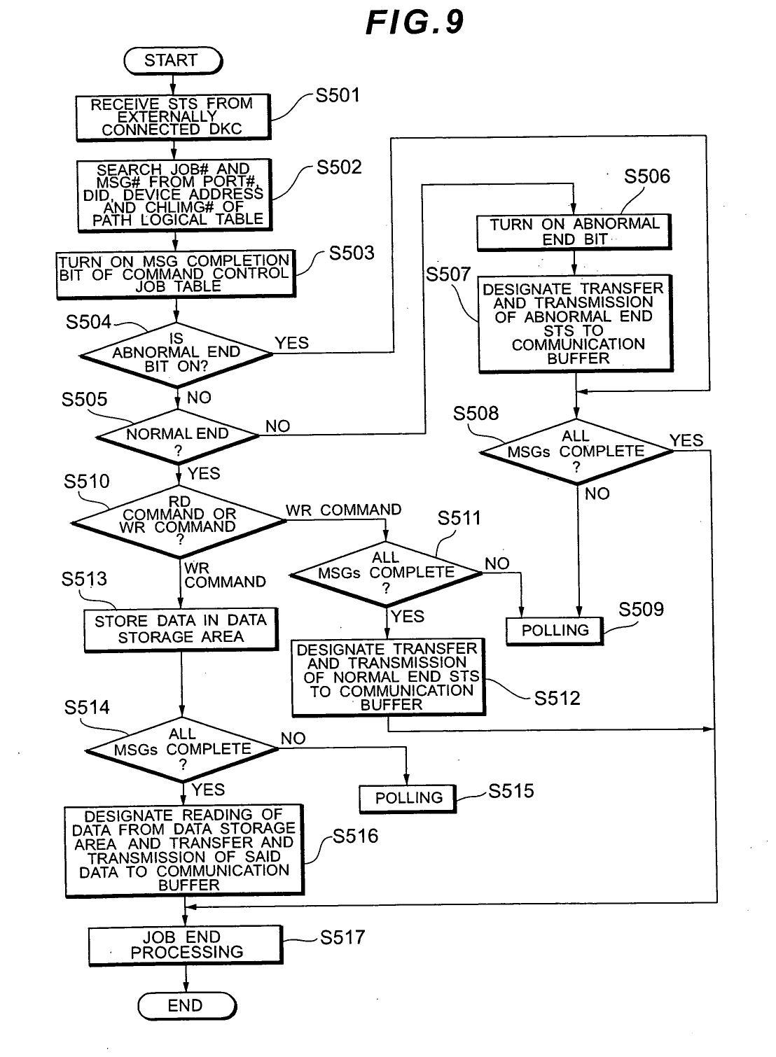

Next, the processing when the host connected DKC receives a reply from the externally connected DKC is explained with reference to FIG. 9.

When the channel control processor 54 receives a completion report (STS) indicating the completion of MSG processing from the externally connected DKC (S501), it refers to the path management table and searches for the JOB# and MSG# of the processed MSG based on the Port#, DID, Device Address and CHLIMG# (S502). Then, the channel control processor 54 sets “1” as the MSG Completion Bit of the processed MSG from the MSG Completion Control Information of the command control job table (S503).

Next, the channel control processor 54 refers to the command control job table and checks whether the Abnormal End Bit of the JOB is “1” (S504). When the Abnormal End Bit of the JOB is “1” (S504; YES), since it is not necessary to perform the respective processing steps described later, the channel control processor 54 determines whether the processing of all MSGs is complete (S508). When the processing of some MSGs is not complete (S508; NO), the channel control processor 54 waits for the reply of such incomplete MSGs (S509). When the processing of all MSGs is complete (S508; YES), the channel control processor 54 sets the JOB status of the command control job table as “Not Active”, and further clears the Abnormal End Bit, number of MSGs and MSG Completion Control Information, and performs the end processing of the JOB (S517).

Meanwhile, when the Abnormal End Bit of the JOB is “0” (S504; NO), the channel control processor 54 determines whether the JOB ended normally (S505). When the JOB did not end normally (S505; NO), the channel control processor 54 sets “1” as the Abnormal End Bit of the command control job table (S506), forwards the Abnormal End STS to the communication buffer 53, and designates the protocol control processor 63 to make a transmission to the host system 10 (S507). Subsequently, the channel control processor 54 performs the processing steps of S508 and S509 described above.

Meanwhile, when the JOB ended normally (S505; YES), the channel control processor 54 determines whether the normally ended JOB is a read-type command or a write-type command (S510). In the case of a write-type command, the channel control processor 54 determines whether the processing of all MSGs is complete (S511). When the processing of some MSGs is not complete (S511; NO), the channel control processor 54 waits for the reply of such incomplete MSGs (S509). When the processing of all MSGs is complete (S511; YES), the channel control processor 54 forwards the completion report (STS) indicating the normal end to the communication buffer 53, and designates the protocol control processor 63 to make a transmission to the host system 10 (S512). Subsequently, the channel control processor 54 performs the processing step of S517 described above.

Meanwhile, in the case of a read-type command, the channel control processor 54 stores the read data of each MSG in the data storage area on the cache memory 31 (S513). Then, the channel control processor 54 determines whether the processing of all MSGs is complete (S514), and, when the processing of some MSGs is not complete (S514; NO), it waits for the reply of such incomplete MSGs (S515). When the processing of all MSGs is complete (S514; YES), the channel control processor 54 reads the read data from the data storage area, forwards this to the communication buffer 53, and designates the protocol control processor 63 to make a transmission to the host system 10 (S516). Subsequently, the channel control processor 54 performs the processing step of S517 described above.

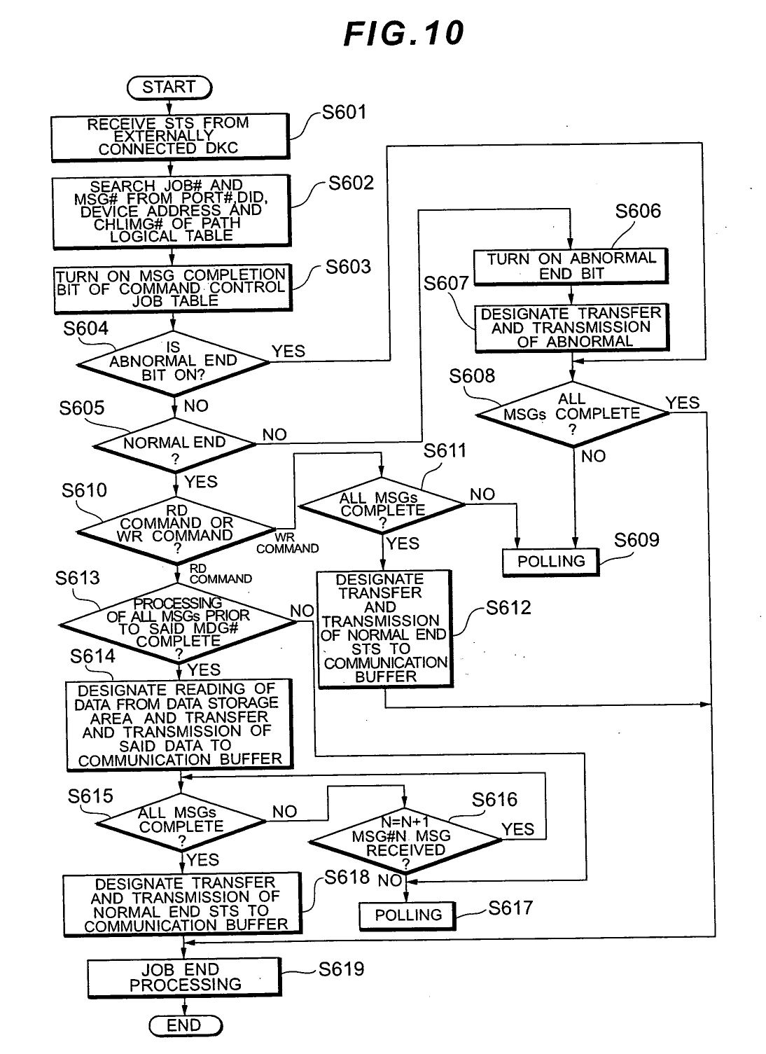

Next, in a case where the host connected DKC receives a read completion report of each MSG from the externally connected DKC, the processing of performing the first-out of read data to the host system 10 before the read data of all MSGs are assembled is explained with reference to FIG. 10. Since the processing steps of S601 to S610 are respectively the same as the processing steps of S501 to S510 described above, the detailed explanation thereof is omitted.

When the normally ended JOB is a read-type command, the channel control processor 54 determines whether the processing of all MSGs prior to such MSGs that received the read completion report is complete (S613). In other words, when the MSG# of such MSGs that received the read completion report is N, the channel control processor 54 determines whether the processing of MSGs of MSG#0 to MSG# (N−1) is complete. When any MSG among MSG#0 to MSG# (N−1) is not complete (S613; NO), the channel control processor 54 waits for the completion of processing of such incomplete MSG (S617).

Meanwhile, when the processing of all MSGs of MSG#0 to MSG# (N−1) is complete (S613; YES), the channel control processor 54 reads the read data of the MSG of MSG#N from the data storage area, forwards this to the communication buffer 53, and designates the protocol control processor 63 to make a transmission to the host system 10 (S614).

Next, the channel control processor 54 determines whether the transmission of read data of all MSGs is complete (S615). When the processing of some MSGs is not complete (S615; NO), the value of N is incremented by “1”, and the channel control processor 54 determines whether the processing of the MSG of MSG# (N+1) is complete (S616). When the processing of any MSG among the MSGs processed from MSG# (N+1) onward is not complete (S616; NO), the channel control processor 54 waits for the completion of processing of such MSG (S617).

Meanwhile, when the processing of the MSG of MSG# (N+1) is complete (S616; YES), the channel control processor 54 reads the read data of the MSG of MSG# (N+1) from the data storage area, forwards this to the communication buffer 53, and designates the protocol control processor 63 to make a transmission to the host system 10 (S614).

As described above, the loop of S614 to S616 is repeatedly executed until the processing of all MSGs is complete. When the processing of all MSGs is complete (S615; YES), the channel control processor 54 forwards the completion report (STS) indicating the normal end to the communication buffer 53, and designates the protocol control processor 63 to make a transmission to the host system 10 (S618). Next, the channel control processor 54 sets the JOB Status of the command control job table to “Not Active”, further clears the Abnormal End Bit, number of MSGs and MSG Completion Control Information, and performs the end processing of the JOB (S619).

As described above, by performing the first-out of the read data to the host system 10 before the read data of all MSGs are assembled, the response performance to designations from the host system 10 can be improved.

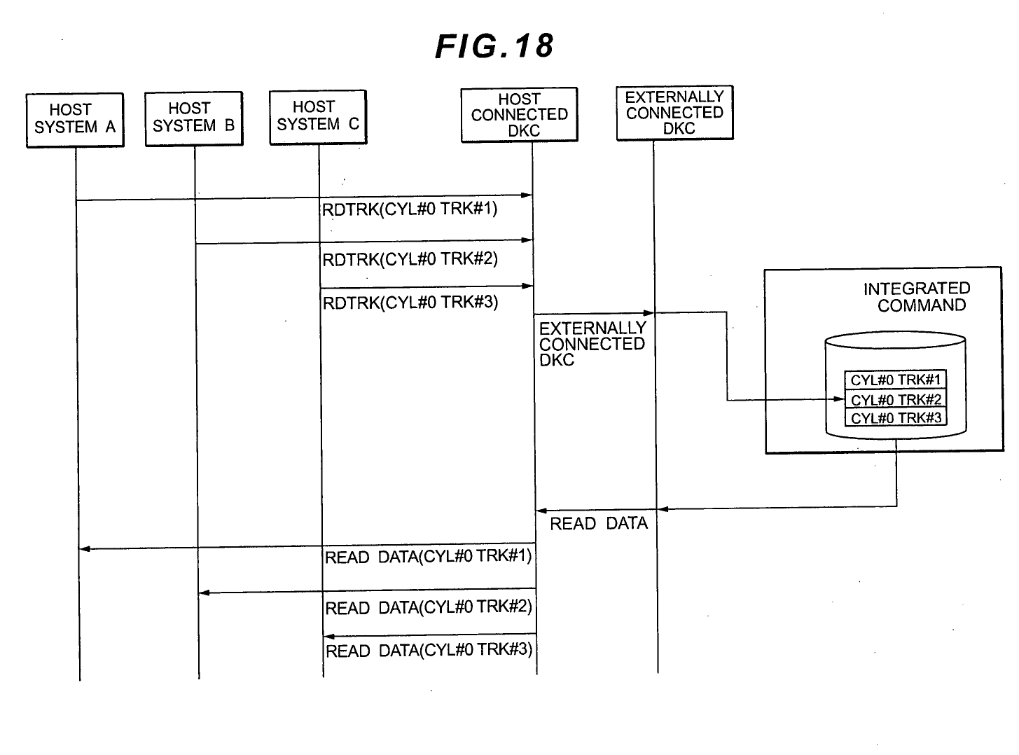

Next, the integration processing of the CCW chain is explained with reference to FIG. 18. In a case where the host connected DKC is connected to a plurality of host systems A, B, C, when the host connected DKC receives a command (CCW chain) from each host system A, B, C, the channel control processor 54 may integrate the commands from each host system A, B, C to newly create a single command, and transmit this new command to the externally connected DKC. For example, when each command from each host system A, B, C is rearranged in the track order, if this becomes a sequential access, each command may be integrated and reorganized as a new single command for sequential access.

In the example illustrated in FIG. 18, a command for reading the data of TRK#1 of CYL#0 is transmitted from host system A, a command for reading the data of TRK#2 of CYL#0 is transmitted from host system B, and a command for reading the data of TRK#3 of CYL#0 is transmitted from host system C, respectively. When these commands are rearranged in the track order, these may be substituted with a command for sequentially reading the data of TRK#1 to TRK#3 of CYL#0. The channel control processor 54 integrates these commands and creates a new command, and transmits this to the externally connected DKC. Then, the read data sequentially read from TRK#1 to TRK#3 of CYL#0 is sent from the externally connected DKC to the host connected DKC. The channel control processor 54 divides this read data and transmits the read data of TRK#1 of CYL#0, read data of TRK#2 of CYL#0 and read data of TRK#3 of CYL#0 to the requesting host systems A, B, C, respectively.

As described above, since the overhead on the command receiving side will decrease by integrating a plurality of commands from a plurality of host systems, the response performance will improve. Further, since the number of frames to be transmitted to the externally connected DKC will also decrease, the response performance will improve. For instance, in the foregoing example, conventionally, the externally connected DKC needed to possess at least three or more BB credits. According to the present embodiment, however, the externally connected DKC only needs to possess one or more BB credits. Moreover, since the prior read function will operate as a result of integrating the commands, the response performance will improve.

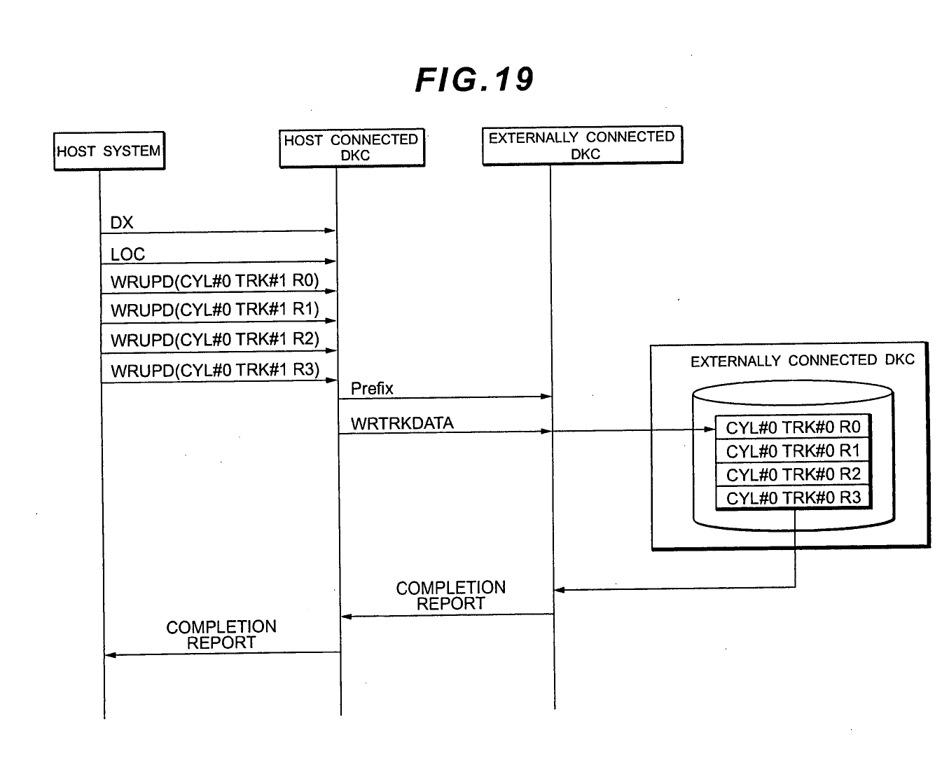

Another example of integrating the CCW chain is explained with reference to FIG. 19. The host connected DKC may also integrate the CCW chain received from the host system in command units and transmit this to the externally connected DKC.

For example, considered is a case where

DX/LOC/WRUPD/WRUPD/WRUPD/WRUPD is transmitted from the host system to the host connected DKC as the CCW chain for providing a designation of writing data in record 0 to record 3 of track number 1 of cylinder number 0 of the externally connected DKC. Since the issuance of a plurality of WRUPDs for providing a designation of writing the data of one record means a designation for writing the data in a plurality of records has been provided, the plurality of WRUPD commands may be substituted with a WRTRKDATA command. Further, since DX/LOC is a command for determining the position of the record indicating from where the data should be written, this command may be substituted with a Prefix command. In the foregoing example, the host connected DKC may substitute DX/LOC/WRUPD/WRUPD/WRUPD/WRUPD received from the host system with Prefix/WRTRKDATA, and transmit this to the externally connected DKC. Based on this command integration, the number of CCW chains will change from 6 to 2. When the host connected DKC receives the completion report indicating the completion of writing from the externally connected DKC, it transmits a completion report indicating the completion of writing to the host system.

As an example of integrating the CCW chain in command units, in addition to the foregoing example, for instance, an example of substituting a plurality of WRCKDs with WRFULLTRK, or an example of substituting a plurality of RDCKDs with RDTRK may also be considered.

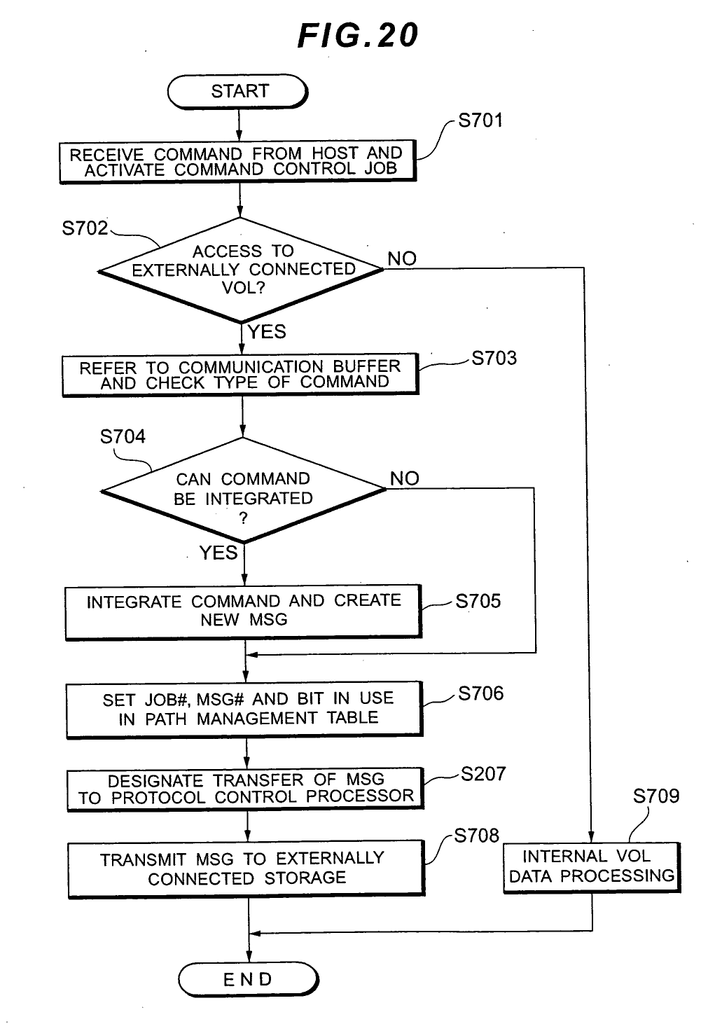

Details regarding the integration processing of the CCW chain in command units are now explained with reference to FIG. 20. Since the processing steps of S701, S702 and S706 to S709 are respectively the same as the processing steps of S101, S102 and S107 to S110 described above, the detailed explanation thereof is omitted.

As described above, the command (CCW chain) transmitted from the host system 10 to the host connected DKC is stored in the reception register 62 via the port 51, and further forwarded to the communication buffer 53. The channel control processor 54 refers to the communication buffer 53, and checks the type of command (S703). If the command can be integrated (S704; YES), the channel control processor 54 integrates the command and creates a new MSG (S705). Meanwhile, if the command cannot be integrated (S704; NO), the channel control processor 54 proceeds to the processing of S706.

As a result of integrating the CCW chain in command units, the overhead on the command receiving side (externally connected DKC) will decrease, and the response performance will improve. Further, since the number of frames to be transmitted and received between the host connected DKC and externally connected DKC will decrease, the performance will improve. For instance, in the foregoing example, in order to transmit DX/LOC/WRUPD/WRUPD/WRUPD/WRUPD from the host connected DKC to the externally connected DKC, there must be six or more BB credits of the target port of the externally connected DKC, but with this Prefix/WRTRKDATA, only two or more BB credits of the target port of the externally connected DKC will be required. When the distance between the host connected DKC and the externally connected DKC becomes a long distance, the performance will change according to the number of BB credits of the target port. Thus, by integrating commands, the performance can be improved.

Next, an example where the host connected DKC that received a command (CCW chain) from the host system determines whether to integrate or divide the command, and performs command integration or command division is explained.

As information for the channel control processor 54 to determine whether to integrate or divide the command, for instance, the buffer usage rate of the target port of the externally connected DKC can be used. A buffer usage rate is a value obtained by dividing the number of buffers in use with the number of BB credits. If the buffer usage rate of the target port is high, since this means that the empty buffer quantity of the target port is small, when an attempt is made for dividing the command and transmitting a plurality of commands to the target port in the foregoing case, there may be cases where the commands cannot be transmitted due to insufficiency of empty buffers of the target port. Thus, when the buffer usage rate of the target port is high, by executing command integration, the number of frames to be transmitted to the target port can be reduced, and, artificially, numerous commands can be issued to the externally connected DKC.

Meanwhile, when the buffer usage rate of the target port is low, since this means that the empty buffer quantity of the target port is large, by dividing the command and transmitting a plurality of commands to the target port in the foregoing case, the processing speed can be improved by performing parallel processing to these plurality of commands at the externally connected DKC.

As described above, by properly using command integration or command division according to the buffer usage rate of the target port, the processing capacity of the overall system can be improved. In particular, when the externally connected path connecting the host connected DKC and externally connected DKC is of a long distance, since much time will be required until the frame is transmitted from the initiator port to the target port, it will be difficult for the buffer of the target port to become empty. Even in the foregoing case, by properly using command integration or command division according to the buffer usage rate of the target port, the processing capacity of the overall system can be maximized.

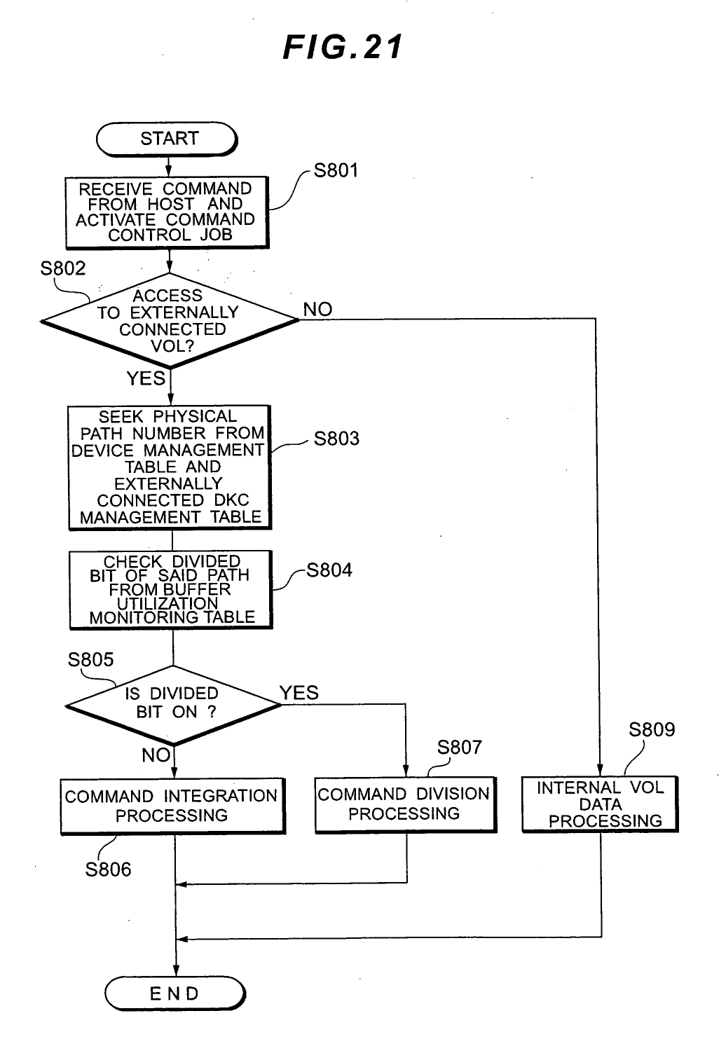

Details regarding the command integration/division processing are now explained with reference to FIG. 21. Since the processing steps of S801, S802 and S808 are respectively the same as the processing steps of S101, S102 and S110 described above, the detailed explanation thereof is omitted.

The channel control processor 54 seeks the physical path number of the externally connected path from the device management table (FIG. 13) and the externally connected DKC management table (FIG. 14) (S803). Next, the channel control processor 54 refers to the buffer usage rate monitoring table (FIG. 23) and checks the divided Bit of the physical path having the physical path number sought at S803 (S804).

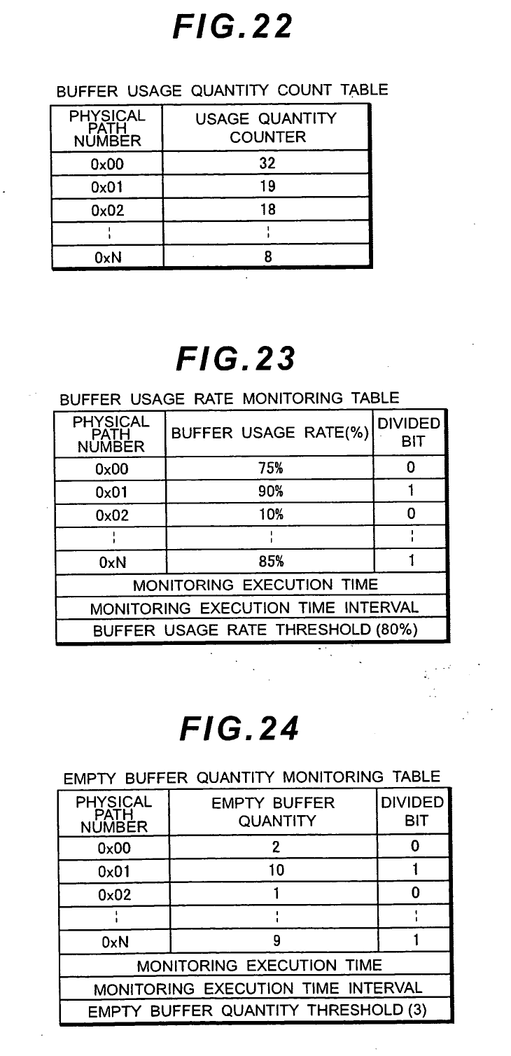

The buffer usage monitoring table illustrated in FIG. 23 is a table for monitoring the buffer usage rate of each physical path. The buffer usage rate (%) stores the average value of the buffer usage rate of each physical path during the execution time of monitoring. As described above, a buffer usage rate is a value obtained by dividing the number of buffers in use with the number of BB credits. The number of buffers in used in the target port can be sought from the buffer usage quantity count table depicted in FIG. 22. This buffer usage quantity count table is a table for counting the number of buffers in use in the target port. “0” is stored as the initial value in the usage quantity counter of each physical path upon link initialization between the host connected DKC and the externally connected DKC. Subsequently, +1 is counted in the target port each time one frame is transmitted, and −1 is counted each time the initiator port receives a buffer release notification (R-RDY) from the target port. Meanwhile, the number of BB credits of the target port can be sought from the second path management table (FIG. 16).

As shown in FIG. 23, when the buffer usage rate is higher than a prescribed threshold, “0” is stored in the divided Bit, and when the buffer usage rate is lower than a prescribed threshold, “1” is stored in the divided Bit. The divided Bit of the physical path being set to “0” means that the command flowing in such physical path should be integrated. Meanwhile, the divided Bit of the physical path being set to “1” means that the command flowing in such physical path should be divided. In the example illustrated in FIG. 23, since 80% is set as the threshold of the buffer usage rate, the divided Bit of the physical path of physical path number 0x00 having a buffer usage rate of 75% is set to “0”. Meanwhile, the divided Bit of the physical path of physical path number 0x01 having a buffer usage rate of 95% is set to “1”. The value of the divided Bit of other physical paths is set in a similar manner.

When the divided Bit is set to “0” (S805; NO), the channel control processor 54 performs command integration (S806). As a specific processing method of command integration, for instance, as described above, when each command is rearranged in the track order and this becomes a sequential access, these commands may be substituted with a new single command for sequential access, or be integrated in command units.

Meanwhile, when the divided Bit is set to “1” (S805; YES), the channel control processor 54 performs command division (S807). As a specific processing method of command division, for instance, as described above, the command may be divided in a number equal to the number of paths, or the number of CCW chains to be transmitted to each path may be changed according to the busy rate of each path, I/O response time of each path, or number of BB credits of the target port to be connected to each path. Further, as the unit for dividing the command, for example, track units or cylinder units may be used.

Incidentally, as information for the channel control processor 54 to determine whether to integrate or divide the command, this is not limited to the foregoing buffer usage rate, and various types of information may be used. For instance, the empty buffer quantity monitoring table depicted in FIG. 24 may be used. This empty buffer quantity monitoring table is a table for monitoring the empty buffer quantity of the target port of the externally connected DKC. The number of BB credits is stored as the initial value in the empty buffer quantity of each physical path. Subsequently, −1 is counted each time one frame is transmitted from the initiator port to the target port, and +1 is counted each time the initiator port receives a buffer release notification (R-RDY) from the target port. When the empty buffer quantity is greater than a prescribed threshold, “1” is stored in the divided Bit, and when the empty buffer quantity is less than a prescribed threshold, “0” is stored in the divided Bit. In the example illustrated in FIG. 24, since 3 is set as the threshold of the empty buffer quantity, the divided Bit of the physical path of physical path number 0x00 having an empty buffer quantity of 2 is set to “0”. Meanwhile, the divided Bit of the physical path of physical path number 0x01 having an empty buffer quantity of 10 is set to “1”. The value of the divided Bit of the other physical paths is set in a similar manner.

In addition to the above, for instance, the channel control processor 54 may determine whether to integrate or divide the command according to the number of BB credits of the target port of the externally connected DKC. When the number of BB credits is greater than a prescribed threshold, the command may be divided and, when the number of BB credits is less than a prescribed threshold, the command may be integrated.

As another example, the channel control processor 54 may monitor the performance of the storage system in order to determine whether to integrate or divide the command. The channel control processor 54 may integrate or divide the command for a fixed period of time and measure the command processing time of the externally connected DKC in each of the foregoing cases. The channel control processor 54 may then determine whether to integrate or divide the command according to such processing time.

Incidentally, in the foregoing explanation, although exemplified was a storage system in which the actual volume of the externally connected DKC was mapped to the virtual device of the host connected DKC, this does not necessarily mean that the actual volume of the externally connected DKC has to be mapped to the virtual device of the host connected DKC. The present invention may also be employed in a storage system where a host connected DKC is connected to an externally connected DKC, and which is configured such that the host connected DKC forwards the command from the host system to the externally connected DKC. The specific processing method of dividing or integrating the command (CCW chain) in the foregoing storage system is the same as the processing methods described above.

We claim:

1. A storage controller connected to a host system and an externally connected storage controller, and which performs data processing according to a request from said host system, comprising:
a virtual device mapped with an actual volume of said externally connected storage controller; and
a channel controller for controlling the access to said actual volume mapped to said virtual device according to the request from said host system;
wherein said channel controller divides a CCW chain transmitted from said host system for said host system to access said actual volume, and transmits each of the plurality of divided CCW chains to said externally connected storage controller.

2. The storage controller according to claim 1, wherein said channel controller distributes each of the plurality of divided CCW chains to a plurality of paths upon transmitting each of said plurality of divided CCW chains to said externally connected storage controller.

3. The storage controller according to claim 2, wherein said path is a physical path for connecting said storage controller and said externally connected storage controller.

4. The storage controller according to claim 2, wherein said path is a plurality of logical paths set in the same physical path for connecting said storage controller and said externally connected storage controller.

5. The storage controller according to claim 2, wherein said channel controller divides said CCW chain into a number equal to the number of paths.

6. The storage controller according to claim 2, wherein said channel controller changes the number of CCW chains to be transmitted to each path according to the busy rate of each path.

7. The storage controller according to claim 2, wherein said channel controller changes the number of CCW chains to be transmitted to each path according to the I/O response time of each path.

8. The storage controller according to claim 2, wherein said channel controller changes the number of CCW chains to be transmitted to each path according to the number of BB credits of a target port of said externally connected storage controller to be connected to said path.

9. The storage controller according to claim 2, wherein said channel controller divides said CCW chain into a plurality of CCW chains in track units or cylinder units.

10. The storage controller according to claim 2, wherein said channel controller issues a completion report to said host system at the stage when every reply of said plurality of divided CCW chains is returned from said externally connected storage controller.

11. The storage controller according to claim 1, wherein, when said channel controller receives from said externally connected storage controller the reply of some CCW chains among said plurality of divided CCW chains in a case where the request from said host system is the reading of data from said actual volume, said channel controller performs the first-out of read data to said host system while maintaining the sequence of read data without waiting for every reply of said plurality of divided CCW chains.

12. A storage controller connected to a plurality of host systems and an externally connected storage controller, and which performs data processing according to a request from said plurality of host systems, comprising:
a virtual device mapped with an actual volume of said externally connected storage controller; and
a channel controller for controlling the access to said actual volume mapped to said virtual device according to the request from said host system;
wherein said channel controller substitutes a plurality of commands transmitted from each of said plurality of host systems for each of said plurality of host systems to access said actual volume with a single command, and transmits said single command to said externally connected storage controller.

13. The storage controller according to claim 12, wherein, when said channel controller rearranges the plurality of commands transmitted from each of said plurality of host systems, said channel controller substitutes said plurality of commands with said single command subject to this becoming a sequential access to said actual volume.

14. A storage system comprising a first storage controller connected to a host system and a second storage controller connected to said first storage controller,
wherein said first storage controller comprises:
a virtual device mapped with an actual volume of said second storage controller; and
a channel controller for controlling the access to said actual volume mapped to said virtual device according to a request from said host system;
wherein said channel controller divides a CCW chain transmitted from said host system for said host system to access said actual volume, and transmits each of the plurality of divided CCW chains to said second storage controller; and
said second storage controller performs simultaneous parallel processing to each of said plurality of divided CCW chains.

15. The storage system according to claim 14, wherein said channel controller distributes each of the plurality of divided CCW chains to a plurality of paths upon transmitting each of said plurality of divided CCW chains to said second storage controller.

16. The storage system according to claim 15, wherein said path is a physical path for connecting said first storage controller and said second storage controller.

17. The storage system according to claim 15, wherein said path is a plurality of logical paths set in the same physical path for connecting said first storage controller and said second storage controller.

18. The storage system according to claim 15, wherein said channel controller divides said CCW chain into a number equal to the number of paths.

19. The storage system according to claim 15, wherein, when said channel controller receives from said second storage controller the reply of some CCW chains among said plurality of divided CCW chains in a case where the request from said host system is the reading of data from said actual volume, said channel controller performs the first-out of read data to said host system while maintaining the sequence of read data without waiting for every reply of said plurality of divided CCW chains.

20. The storage system according to claim 15, wherein said first storage controller is connected to a plurality of host systems; and
said channel controller substitutes a plurality of commands transmitted from each of said plurality of host systems for each of said plurality of host systems to access said actual volume with a single command, and transmits said single command to said second storage controller.

21. A storage system comprising a first storage controller connected to a host system and a second storage controller connected to said first storage controller via a physical path,
wherein said first storage controller divides a CCW chain transmitted from said host system for said host system to access a storage device of said second storage controller, and transmits each of the plurality of divided CCW chains to each of a plurality of logical paths set in the same physical path; and
said second storage controller performs simultaneous parallel processing to each of said plurality of divided CCW chains.

22. The storage system according to claim 21, wherein said second storage controller comprises a port to be connected to said first storage controller; and
said first storage controller acquires information regarding the processing status of said port of said second storage controller, and determines whether to divide or integrate the CCW chain transmitted from said host system according to said acquired processing status.
